(19) United States
(12) Patent Application Publication
(10) Pub. No.: US 2003/0013426 A1
(43) Pub. Date: Jan. 16, 2003

(54) Apparatus for canceling leakage signal using even harmonic mixer and method thereof

(76) Inventors: Young Wan Kim, Taejon (KR); Yun Jeong Song, Taejon (KR); Nae-Soo Kim, Taejon (KR); Jeom Hun Lee, Taejon (KR); Ho Jin Lee, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/006,404

(22) Filed: Nov. 30, 2001

(30) Foreign Application Priority Data
Jul. 13, 2001 (KR) 2001-42469

(51) Int. Cl. H04B 1/26

(52) U.S. Cl. 455/196.1; 455/258

(57) ABSTRACT

The present invention utilizes an even harmonic mixer for canceling a local oscillator (LO) leakage signal. The apparatus for canceling the LO leakage signal includes an in-phase divider, an intermediate frequency (IF) phase divider, an even harmonic mixers, an RF signal phase combiner and a band pass filter (BPF). The in-phase divider divides an LO signal into two in-phase LO signals, wherein the LO signal is inputted from an exterior LO. The IF phase divider divides an IF signal into two out-of-phase IF signals of which a phase difference is 90°, wherein the IF signal is inputted from an exterior means. The even harmonic mixer outputs two out-of phase RF signals of which the phase difference is 90°, after even-harmonic mixing of two in-phase LO signals divided by the in-phase divider and two out-of-phase IF signals divided by the IF phase divider. The RF signal phase combiner plays a role in canceling an image signal in the RF signal by combining two out-of-phase RF signals outputted from the even harmonic mixer. The BPF is used for canceling a residual component of the leakage signal in the RF signal outputted from the RF signal phase combiner.

### FIELD OF THE INVENTION

The present invention relates to an apparatus for canceling a leakage signal; and, more particularly, to an apparatus for canceling a leakage signal and a method thereof, for canceling a local oscillator leakage effectively by using an even harmonic mixer provided with an anti parallel diode pair (APDP) and a mutiplexer.

### DESCRIPTION OF THE PRIOR ART

Generally, when a signal frequency is up-converted in a communication system where a low blocking signal of base band signals is very near to a direct current (D.C), a local oscillator (LO) signal is likely to be close to the low blocking signal in a pass band. Therefore, this signal cannot be canceled by using a conventional band pass filter (BPF). In the above communication system, an LO leakage signal may cause a vector error. In addition, it is difficult to utilize the BPF at the pass band. In the signal transmitted through an amplifier disposed on a rear end, the LO signal and an intermediate frequency (IF) signal are modulated to each other so that a plurality of noise signals may be mixed in the pass band.

Thus, it is only possible to utilize a conventional method for canceling the leakage signal using the BPF under the condition that the LO signal and a radio frequency (RF) signal are separated from each other, sufficiently. In case of the above condition, the leakage signal can be canceled by using the conventional BPF with ease.

On the contrary with the above condition, if the LO signal and the RF signal exist very closely, the leakage signal may be canceled by using a saw filter with a good skirt property or by using a multi-stage BPF scheme. However, in case of using the saw filter, the skirt property is enhanced but it is difficult to transmit a desired RF signal because the saw filter cannot satisfy the desired bandwidth.

Meanwhile, in case of using a micro-strip typed BPF, it satisfies the desired bandwidth but it has a poor skirt property so that it is difficult to cancel the LO leakage signal when the LO signal and the RF signal are exist very closely.

Referring to FIG. 1, there is shown a schematic view setting forth a general leakage phenomenon of the LO signal. In particular, FIG. 1 illustrates the leakage phenomenon of the LO signal generated by converting the frequency of the transmission signal which is close to the D.C signal. As depicted in FIG. 1, in a frequency converter of the satellite communication and the communication system where a transmission signal band B and a D.C. component A exist very closely to each other, the LO signal C becomes closely to a transmission band signal D so that it is difficult to cancel the LO leakage signal using the conventional method. Furthermore, in case of utilizing the method using the BPF and a band-limited filter, an RF characteristic and an RF performance of the transmission signal may be deteriorated due to a group delay of the transmission signal. Thus, it is necessary to develop a new method for canceling the LO leakage signal component while preserving the RF characteristic of the transmission signal band.

Referring to FIG. 2, there is shown a schematic view setting forth a conventional apparatus for canceling the LO leakage signal.

As represented in FIG. 2, the apparatus for canceling the LO leakage signal comprises a BPF 40 and a notch filter 50, a frequency converter 10, an LO 20 and an RF amplifier 30. The BPF 40 plays a role in passing a required transmission band signal except the leakage signal in the transmission band of which the frequency is converted by the LO 20 at the frequency converter 10. The notch filter 50 is used for canceling the leakage signal in the transmission band that is transmitted through the BPF 40.

However, according to the conventional method for canceling the leakage signal by means of the filter, a deviation of a resonance frequency occurs due to an imperfection of the parts between an inductor and a capacitor which is constituent parts for use in the filter. Thus, it is difficult to cancel out the leakage signal exactly. In addition, it is necessary to use a plurality of filters in using the conventional method for canceling the leakage signal effectively.

In a high-speed wireless communication system, a frequency difference between the LO signal and a frequency-converted output signal is small owing to a low frequency performance of a modulator. Thus, the characteristic of the group delay may be deteriorated eventually when the LO leakage signal is being cancelled.

Several prior arts regarding a leakage canceller scheme have been introduced up to now, which will be set forth in detail hereinafter.

A first prior art is disclosed in Korean republished No. 99-0061919, published on Jul. 26, 1999, entitled “Apparatus for Canceling Local Oscillator Leakage Signal”. In a disclosure, by utilizing the signal equal in frequency and amplitude but opposite in phase to the leakage signal (hereinafter, referred to as inverse phase signal), the LO leakage signal component is canceled by combining the leakage signal and the inverse phase signal.

A second prior art is disclosed in an article, “New Method for Canceling Local Oscillator Leakage Signal, KEEC, Vol. 11, Lett. 2, pp. 294-301, February 2000”. In a disclosure, as similar to the first prior art, the method for canceling the leakage signal is also performed by combining the leakage signal and the inverse phase signal equal in the frequency and the amplitude but opposite in phase to the leakage signal.

Theoretically, the leakage signal may be canceled out exactly according to the first and the second prior art methods. But in practice, it is difficult to utilize the inverse phase signal exactly equal in the frequency and the amplitude but opposite in phase to the leakage signal so that it may be hard to embody the leakage cancellation system using the first and the second prior art methods. Moreover, the prior art methods have problem that a cancellation performance for the leakage signal is deteriorated due to errors induced from the parts used for canceling the leakage signal component, induced from the temperature variation and induced from the signal path difference between the LO signal and the inverse phase signal.

A third prior art is disclosed by Tiller and Nisbet in U.S. Pat. No. 5,918,167, entitled “Quadrature Downconverter Local Oscillator Leakage Canceller”. U.S. Pat. No. 5,918,167 discloses a method for canceling the leakage signal using the inverse phase signal of which the phase difference is 180° in a quadrature downconverter structure. This method has an advantage that it can be adjustable to the change of the leakage signal by controlling the amplitude of the inverse phase signal. However, the third prior art method utilized a D.C. signal as a control signal so that it is difficult to separate the control signal by means of the low BPF because the control signal and the other signal component are mixed together in a direct conversion scheme. Additionally, in the high-speed wireless communication system having a modulator using the low frequency, it is also difficult to separate the control signal because the transmission band signal and the LO signal are very near to each other.

Finally, a fourth prior art is disclosed in Korean registration No. 99-0061919, registered on Jul. 26, 1999, entitled “Apparatus for Protecting Phase Offset Receiver”. The fourth method discloses a method for canceling the leakage signal in case that the signal outputted from the transmitter leaks into a receiver. As similar to the first prior art method, the fourth method utilizes the inverse phase signal to the leakage signal. Thus, it is not appropriate to compensate a phase difference and an amplitude difference between the leakage signal and the inverse phase signal.

### SUMMARY OF THE INVENTION

It is, therefore, an object of the present invention to provide an apparatus for canceling a leakage signal using an even harmonic mixer incorporating therein a multiplexer and an anti parallel diode pair (APDP).

It is, therefore, another object of the present invention to provide a method canceling a leakage signal using an even harmonic mixer incorporating therein a multiplexer and an anti parallel diode pair (APDP).

In accordance with one aspect of the present invention, there is provided an apparatus for canceling a leakage signal using an even harmonic mixer comprising: an in-phase dividing means for dividing a first signal inputted from a first exterior means into first in-phase signals; a phase dividing means for dividing a second signal inputted from a second exterior means into second out-of-phase signals of which a phase difference is 90°; an even harmonic mixing means for outputting out-of phase radio frequency (RF) signals of which the phase difference is 90°, after even-harmonic mixing of the first in-phase signals outputted from the in-phase dividing means and the second out-of-phase signals outputted from the phase dividing means; an RF signal phase combining means for canceling an image signal by combining the out-of-phase RF signals outputted from the even harmonic mixing means; and a band pass filter (BPF) for canceling a residual component of the leakage signal in the RF signals outputted from the RF signal phase combining means.

In accordance with another aspect of the present invention, there is provided a method for canceling a leakage signal using an even harmonic mixer, the method comprising the steps of: a) dividing a first signal inputted from a first exterior means into first in-phase signals; b) dividing a second signal inputted from a second exterior means into second out-of-phase signals of which the phase difference is 90°; c) generating out-of-phase RF signals of which the phase difference is 90°, after even-harmonic mixing of the first in-phase signals and the second out-of-phase signals; d) canceling out an image signal by combining the out-of-phase signals; and e) canceling out a residual component of the leakage signal in the RF signal.

### BRIEF DESCRIPTION OF THE DRAWINGS

The above and other objects and features of the present invention will become apparent from the following description of the preferred embodiment given in conjunction with the accompanying drawings, in which:

FIG. 1 is a schematic view setting forth a general leakage phenomenon of a local oscillator (LO) signal;

FIG. 2 is a schematic view illustrating a conventional apparatus for canceling an LO leakage signal;

FIG. 3 is a schematic view representing an apparatus for canceling the leakage signal using an even harmonic mixer in accordance with a preferred embodiment of the present invention;

FIG. 4 is a schematic view depicting the even harmonic mixer in accordance with the present invention;

FIG. 5 is a schematic view setting forth an operation mechanism of an anti parallel diode pair (APDP);

FIG. 6 is a graph illustrating an output spectrum for the even harmonic mixer in accordance with the present invention;

FIG. 7 is a table setting forth an up-converting phase correlation of the even harmonic mixer for canceling an image signal in accordance with the present invention; and

FIG. 8 is a flow chart setting forth a method for canceling the leakage signal using the even harmonic mixer in accordance with the present invention.

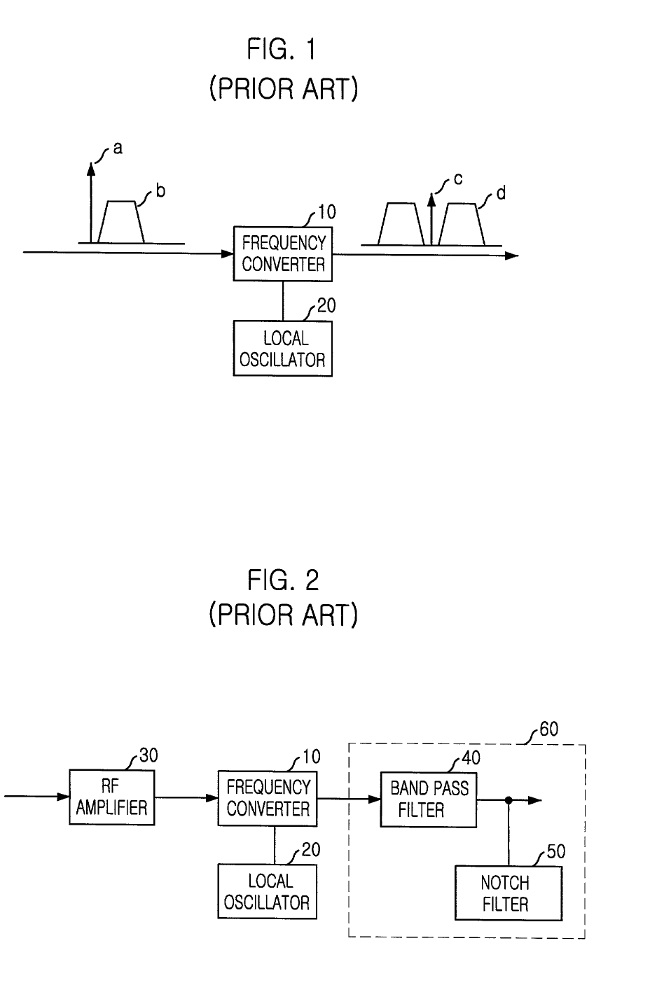

### DETAILED DESCRIPTION OF THE PREFERRED EMBODIMENTS

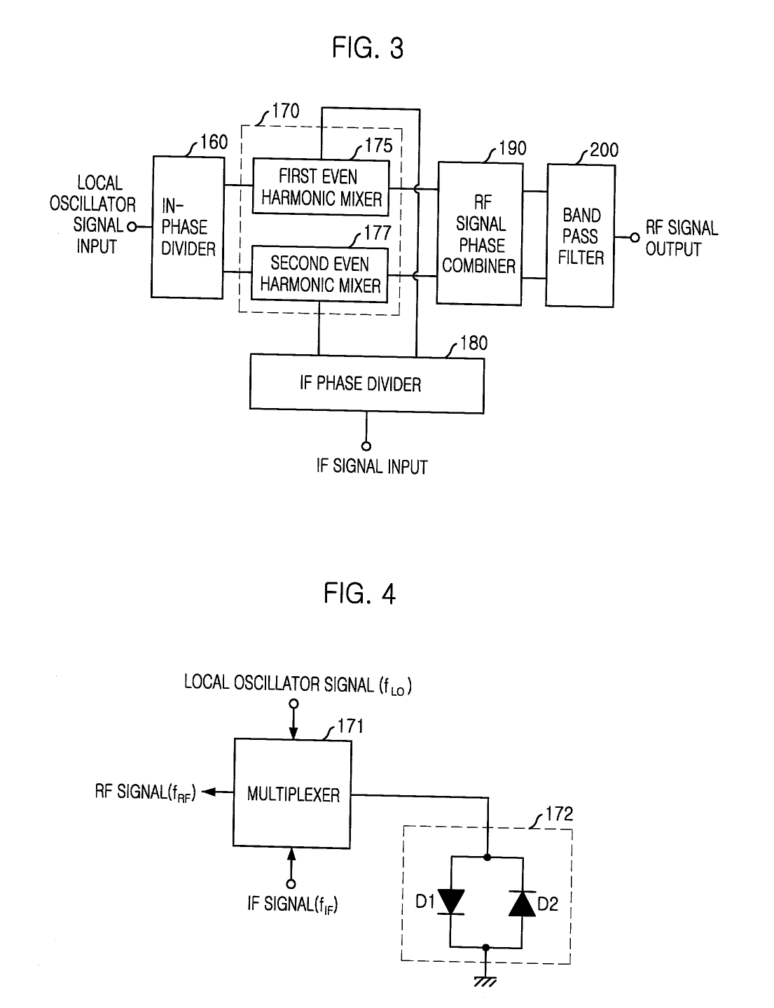

Referring to FIG. 3, there is shown an apparatus for canceling a local oscillator (LO) leakage signal in accordance with a preferred embodiment of the present invention, comprises an in-phase divider 160, an intermediate frequency (IF) phase divider 180, an even harmonic mixer 170 including a first even harmonic mixer 175 and a second even harmonic mixer 177, a radio frequency (RF) signal phase combiner 190 and a band pass filter (BPF) 200. The in-phase divider 160 divides an LO signal into two in-phase LO signals, wherein the LO signal is inputted from an exterior LO. The IF phase divider 180 divides an inputted IF signal into two out-of-phase IF signals of which a phase difference is 90°, i.e., an in-phase IF signal and a quadrature phase IF signal. The even harmonic mixer 170 outputs two out-of phase RF signals of which the phase difference is 90°, after even-harmonic mixing of two in-phase LO signals divided by the in-phase divider 160 and two out-of-phase IF signals divided by the IF phase divider 180. The RF signal phase combiner 190 plays a role in canceling an image signal in the RF signal by combining two out-of-phase RF signals outputted from the even harmonic mixer 170. The BPF 200 is used for canceling a residual component of the leakage signal in the RF signal outputted from the RF signal phase combiner 190.

Referring to FIG. 4, there is shown a schematic view setting forth the even harmonic mixer 170 in detail, including the first even harmonic mixer 175, a second even harmonic mixer 177, each even harmonic mixer 175, 177 having a multiplexer 171 and an anti parallel diode pair (APDP) 172 therein.

The multiplexer 171 generates a desired RF signal by mixing an inputted IF signal and a second RF component of the LO signal. The APDP 172 provided with anti parallel diodes D1, D2 plays a role in suppressing the second RF component of the LO signal within a loop. That is, an output RF signal is outputted after mixing with the second RF component of the LO signal. The second RF component of the LO signal is suppressed by means of the APDP 172 so that a leakage signal component may not appear.

An operation mechanism of the apparatus for canceling the LO leakage signal is more illustrated in detail hereinafter.

To begin with, the IF signal to transmit is inputted into the IF phase divider 180 so that the IF signal is divided into the in-phase IF signal and the quadrature phase IF signal. Thereafter, the in-phase and the quadrature phase IF signals are inputted into the first even harmonic mixer 175 and the second even harmonic mixer 177, respectively. Subsequently, the first and the second even harmonic mixers 175, 177 mix the in-phase and the quadrature phase IF signals with RF signals, using two in-phase LO signals outputted from the in-phase divider 160. Here, the first and the second harmonic mixers 175, 177 incorporating therein the APDP 172, output a mixed component of the IF signal and the second RF component of the LO signal.

In other words, the first even harmonic mixer 175 outputs an in-phase RF signal due to the in-phase IF signal and the even harmonic mixer 177 outputs a quadrature phase RF signal due to the quadrature phase IF signal. The in-phase and the quadrature phase RF signals outputted from the first and the second even harmonic mixers 175, 177 respectively, have an image signal therein, but the LO leakage signal is suppressed by the operation of the APDP 172.

The in-phase and the quadrature phase RF signals outputted from the even harmonic mixer 170, are inputted into the RF signal phase combiner 190 for canceling the image signal. At this time, upper side band (USB) signals of the RF signals outputted from the first and the second even harmonic mixers 175, 177 are combined and transmitted into the BPF 200 through the RF signal phase combiner 190 because the USB signals are in-phase signals. However, lower side band (LSB) signals have the phase difference of 180°, so that the combination of the LSB signals becomes to be null, whereby the image signal is canceled. Namely, the in-phase RF USB signals are only combined and then are transmitted into the BPF 200.

The BPF 200 is used for canceling the residual component of the leakage signal that can be generated due to an imbalance of a gain and of the phase difference of constituent parts, when a circuit for canceling the LO signal is designed. The leakage component of the LO signal is the second RF component, but it is apart away from the transmission signal band. Therefore, the residual component of the leakage signal caused by an incompleteness of constituent parts in the circuit, can be canceled using the conventional BPF.

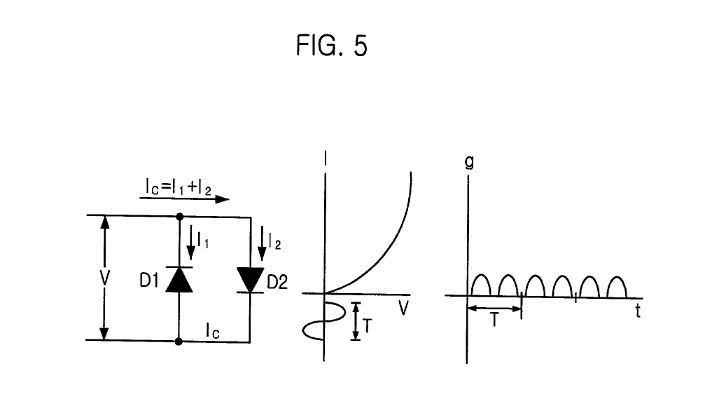

Referring to FIG. 5, there is shown a schematic view setting forth an operation mechanism of the APDP 172. In FIG. 5, a diode current having every frequency of mf_{LO}±nf_{S}, is produced due to the characteristic of the APDP 172. However, total current of the APDP 172 shows such a characteristic that m+n is an odd number, as shown in FIG. 5. In other words, if m+n is an even number, the current is the direct current (D.C.) passing through a basic mixing process and the diode, as described in a following equation 1.

$$i = A cos {ω}_{LO} t + B cos {ω}_{S} t + C cos 3 {ω}_{LO} t + D cos 5 {ω}_{LO} t + E cos ( 2 {ω}_{LO} + {ω}_{S} ) t + F cos ( 2 {ω}_{LO} - {ω}_{S} ) t + Λ \qquad ( Eq . 1 )$$

where, the total current is represented as the component having frequencies of mf_{LO}±nf_{S} in which m+n is the odd number.

That is, the basic mixing process does not appear in the APDP 172 but the even mixing process only appears.

As shown in FIG. 5, the current I_{C} is a summation of a first current I₁ and a second current I₂, wherein the first current I₁ has the opposite direction to that of the second current I₂. Here, the current I_{C} is described as a following equation 2.

$${i}_{C} = \frac{{i}_{S}}{2} \{ 1 + \frac{{V}_{LO}^{2} {V}_{S}^{2}}{2} + \frac{{V}_{LO}^{2}}{2} cos 2 {ω}_{LO} t + \frac{{V}_{LO}^{2}}{2} cos 2 {ω}_{S} t + {V}_{LO} {V}_{S} [ cos ( {ω}_{LO} + {ω}_{S} ) t + cos ( {ω}_{LO} - {ω}_{S} ) t + Λ ] \} \qquad ( Eq . 2 )$$

where, the total current is represented as the component having frequencies of mf_{LO}±nf_{S} in which m+n is an even number, and

I_{C} is total current flowing through the loop of the diodes D1, D2.

From the above equations, it is understood that the APDP 172 suppress a basic frequency and the RF component, and simultaneously, mixes odd number of RFs of the LO signal and suppress an even number of RFs of the LO signal. That is, the APDP 172 has a characteristic that the RF signals are combined and transmitted in case that m+n is the odd number. From the above result, the basic mixing process is suppressed by the APDP 172 and twice the LO signal is operated as an imaginary LO signal.

The even harmonic mixer 170 that has the characteristic as aforementioned, includes the multiplexer 171 and the APDP 172 incorporating therein Schottky barrier diodes D1, D2. Here, mf_{LO}±nf_{S} value is produced, wherein m+n is the odd number but mf_{LO}±nf_{S} is suppressed by the operation mechanism of the APDP 172, wherein m+n is the even number. In other words, 2f_{LO} that is near to a RF channel, i.e., 2f_{LO}±f_{S}, is suppressed in an up-converting process. Therefore, it is possible to obtain a desired value during the transmission of a microwave and a millimeter wave.

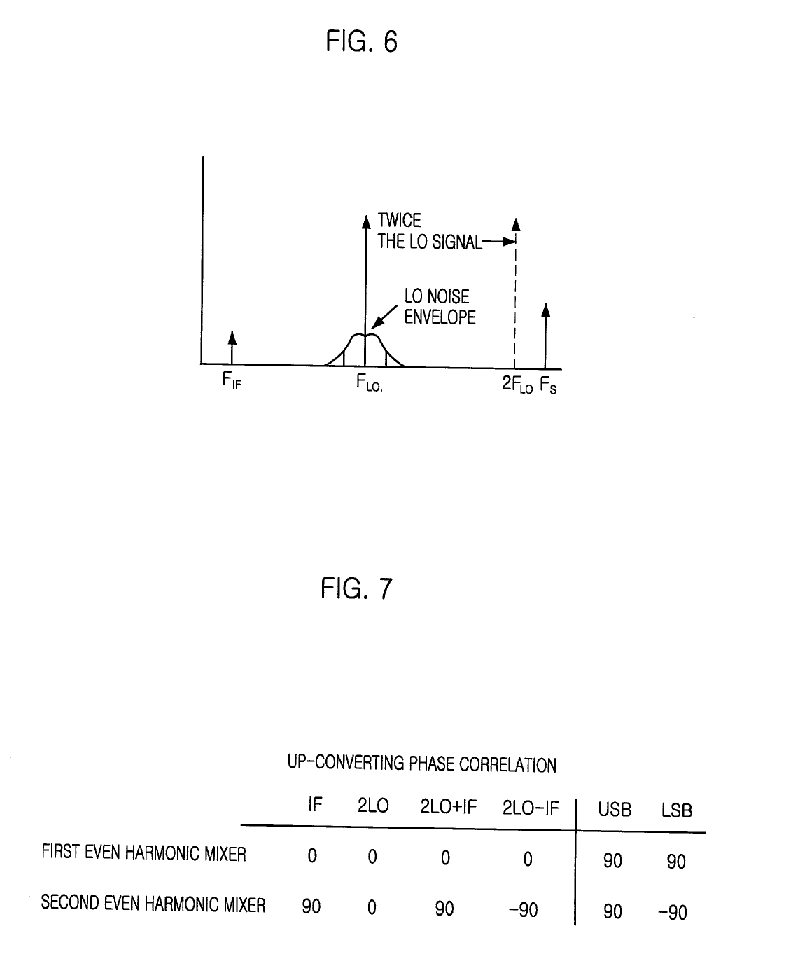

Referring to FIG. 6, there is shown a graph setting forth an output spectrum for the even harmonic mixer in accordance with the present invention.

In FIG. 6, the twice the LO signal is operated as the imaginary LO signal and the image frequency is offset by an imaginary canceller means. The residual component of the leakage signal which is caused by the phase difference and the gain differential between the IF phase divider 180 and the RF signal phase combiner 190, is canceled without any deterioration of the RF characteristic.

Referring to FIG. 7, there is shown a table setting forth an up-converting phase correlation of the even harmonic mixer 170 in accordance with the present invention.

In FIG. 7, the inputted LO signal is divided into two in-phase signals by the in-phase divider 160 and the inputted IF signal is divided into two out-of-phase IF signals of which the phase difference is 90°. Two out-of-phase RF signals of which the phase difference is 90°, is produced by the first and the second even harmonic mixers 175, 177. At this time, desired in-phase RF USB signals are combined with each other at the RF signal phase combiner 190, and undesired out-of-phase RF LSB signals are combined to be null because they have opposite phase to each other.

Therefore, the first and the second even harmonic mixers 175, 177 having each APDP 172, generate the desired RF signal, i.e., 2f_{LO}±f_{S}, by mixing the IF signal and the second RF component of the LO signal. In addition, the second RF component of the LO signal is suppressed within the loop of the APDP 172.

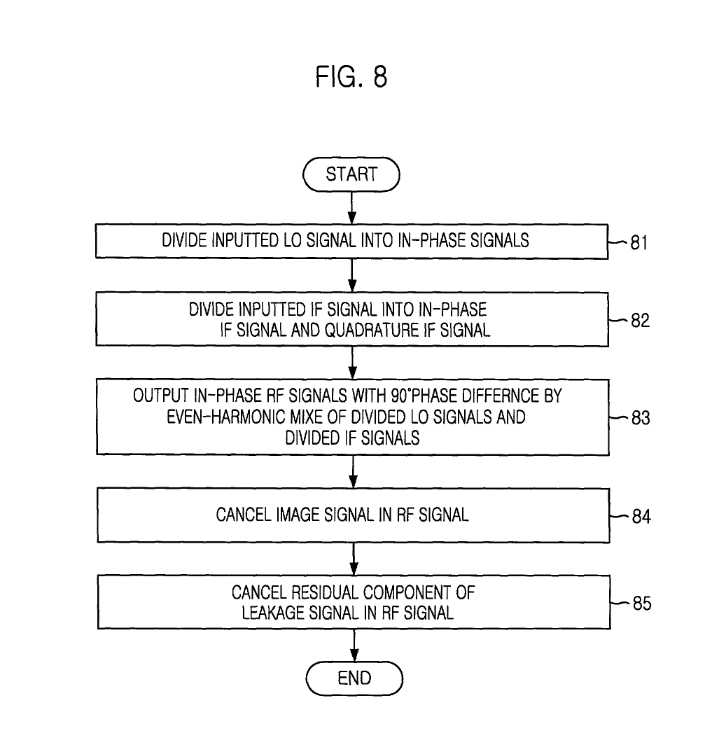

Referring to FIG. 8, there is provided a flow chart setting forth a method for canceling the leakage signal in accordance with the preferred embodiment of the present invention.

As shown in FIG. 8, the method for canceling the leakage signal begins with dividing the LO signal into two in-phase LO signals by the in-phase divider 160, indicated by a step 81.

Thereafter, the IF signal to transmit is divided into two out-of-phase IF signals of which the phase difference is 90° by the IF phase divider 180, indicated by a step 82.

Subsequently, indicated by a step 83, two out-of-phase IF signals of which the phase difference is 90° are mixed to generate two out-of-phase RF signals, using two in-phase LO signals. The first even harmonic mixer 175 outputs an in-phase RF signal due to the in-phase IF signal and the even harmonic mixer 177 outputs a quadrature phase RF signal due to the quadrature phase IF signal. Here, the RF signals have the image signals therein but the LO leakage signal is suppressed by the operation mechanism of the APDP 172.

Thereafter, indicated by a step 84, the image signals in the RF signals outputted from the first and the second even harmonic mixers 175, 177, are canceled while the RF signals are passed through the RF signal phase combiner 190. Among the out-of-phase RF signals, the RF USB signals are combined and transmitted through the RF signal phase combiner 190 into the BPF 200. But, the RF LSB signals are combined with each other, whereby the image signal is canceled, as illustrated already in FIG. 7.

Finally, indicated by a step 85, the RF signal in which the image signal is canceled at the RF signal phase combiner 190, is transmitted into the BPF 200 so that the residual component of the leakage signal is canceled, wherein the residual component of the leakage signal can be induced mainly by an imbalance of the gain and the phase difference of the constituent parts.

As aforementioned, in accordance with the present invention, the LO leakage signal which is generated at the frequency converter in a satellite communication or a communication system, can be effectively canceled using the even harmonic mixer so that it is possible to prevent the undesired wave of the receiver and a performance degradation of the transmitter.

Furthermore, the present invention provides an advantage that the LO signal is separated from the RF signal by utilizing the even harmonic mixer incorporating therein the APDP, whereby the leakage signal can be canceled out easily by means of the conventional BPF.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for canceling a leakage signal using an even harmonic mixer comprising:
an in-phase dividing means for dividing a first signal inputted from a first exterior means into first in-phase signals;
a phase dividing means for dividing a second signal inputted from a second exterior means into second out-of-phase signals of which a phase difference is 90°;
an even harmonic mixing means for outputting out-of phase radio frequency (RF) signals of which the phase difference is 90°, after even-harmonic mixing of the first in-phase signals outputted from the in-phase dividing means and the second out-of-phase signals outputted from the phase dividing means;
an RF signal phase combining means for canceling an image signal by combining the out-of-phase RF signals outputted from the even harmonic mixing means; and
a band pass filter (BPF) for canceling a residual component of the leakage signal in the RF signals outputted from the RF signal phase combining means.

2. The apparatus as recited in claim 1, wherein the even harmonic mixing means includes:
a first even harmonic mixing means for outputting a first RF signal by mixing a quadrature phase second signal outputted from the phase dividing means with an RF signal, using one of the first in-phase signals outputted from the in-phase dividing means; and
a second even harmonic mixing means for outputting an in-phase second signal outputted from the phase dividing means with the RF signal, using the other of the first in-phase signals outputted from the in-phase dividing means.

3. The apparatus as recited in claim 2, wherein the harmonic mixing means includes:
a multiplexer for mixing the second out-of-phase signals outputted from the phase dividing means and the first in-phase signals outputted from the in-phase dividing means; and
an anti parallel diode pair (APDP) for suppressing a basic frequency and an RF component, and simultaneously, mixing odd number of RFs of the LO signal and suppressing an even number of RFs of the LO signal.

4. The apparatus as recited in claim 3, wherein the APDP includes Schottky barrier diodes.

5. A method for canceling a leakage signal using an even harmonic mixer, the method comprising the steps of:
a) dividing a first signal inputted from a first exterior means into first in-phase signals;
b) dividing a second signal inputted from a second exterior means into second out-of-phase signals of which the phase difference is 90°;
c) generating out-of-phase RF signals of which the phase difference is 90°, after even-harmonic mixing of the first in-phase signals and the second out-of-phase signals;
d) canceling out an image signal by combining the out-of-phase signals; and
e) canceling out a residual component of the leakage signal in the RF signal.

6. The method as recited in claim 5, wherein the step c) includes the steps of:
c1) mixing a quadrature phase second signal outputted from the phase dividing means with an RF signal, using one of the first in-phase signals; and;
c2) mixing an in-phase second signal outputted from the phase dividing means with the RF signal, using one of the first divided signals.
